(19) United States
(12) Patent Application Publication
(10) Pub. No.: US 2018/0231507 A1
(43) Pub. Date: Aug. 16, 2018

(54) METHOD AND APPARATUS FOR METAMATERIAL ENHANCED CHAOTIC CAVITY TRANSDUCER

(71) Applicant: Microline Technology Corporation, Traverse City, MI (US)

(72) Inventors: Dean M. Vieau, Traverse City, MI (US); Bruce I. Girrell, Traverse City, MI (US); Johana M. Chirinos, Traverse City, MI (US); Douglas W. Spencer, Rapid City, MI (US)

(21) Appl. No.: 15/897,666

(22) Filed: Feb. 15, 2018

Related U.S. Application Data
(60) Provisional application No. 62/459,272, filed on Feb. 15, 2017.

(51) Int. Cl. G01N 29/265; G01N 29/12; G01N 29/48; G06F 17/14; G01N 29/06; G01N 29/04

(52) U.S. Cl. CPC G01N 29/265; G01N 29/12; G01N 29/043; G06F 17/142; G01N 29/06; G01N 29/48

(57) ABSTRACT

A crack detecting system includes a tool movable along a conduit or structure and having at least one sensing device for sensing cracks in a wall of the conduit or structure. The tool includes at least one component that includes a metamaterial. The system includes an emitting source that has at least one transducer. A processor is operable to process an output of the at least one sensing device. The processor responsively determines cracks present at the wall of the conduit or structure via the processed output.

### CROSS REFERENCE TO RELATED APPLICATION

The present application claims the filing benefits of U.S. provisional application Ser. No. 62/459,272, filed Feb. 15, 2017, which is hereby incorporated herein by reference in its entirety.

### FIELD OF THE INVENTION

The present invention relates generally to a method of detecting cracks in a pipeline or conduit or tubular via a tool or device that is moved along and within the pipeline or conduit or tubular (or moved along an exterior surface of a conduit or tubular or plate or beam or other structure).

### BACKGROUND OF THE INVENTION

It is known to use a sensing device to sense or determine the flaws or defects in pipes and other tubulars. Examples of such devices are described in U.S. Pat. Nos. 8,061,207; 8,201,454; 8,319,494; 8,356,518 and 8,479,577.

### SUMMARY OF THE INVENTION

The present invention provides a crack detecting system that is operable to detect cracks along a conduit. The crack detecting system comprises a tool that is movable along a conduit and that has at least one sensing device for sensing cracks in a wall of the conduit. The system utilizes metamaterials to enhance sensing and performance of the system. A processor (at the tool or remote therefrom) is operable to process an output of the at least one sensing device. Responsive to processing of the output by the processor, the processor is operable to determine cracks at the wall of the conduit.

These and other objects, advantages, purposes and features of the present invention will become apparent upon review of the following specification in conjunction with the drawings.

### BRIEF DESCRIPTION OF THE DRAWINGS

FIG. 1 shows a horizontal cross section of a structure with a tool of the present invention disposed thereat;

FIG. 2 shows a horizontal cross section of a pipe or tubular with another tool of the present invention disposed therein;

FIG. 3 shows a horizontal cross section of a pipe or tubular with another tool of the present invention disposed therein;

FIG. 4 is a block diagram showing post-run data processing stages of the system of the present invention;

FIG. 5 is another block diagram showing real-time data processing in accordance with the present invention;

FIG. 6 is a schematic showing an example of a metamaterial space coiling structure suitable for use with the system of the present invention;

FIG. 7 is a perspective view of an example of a metamaterial focusing structure suitable for use with the system of the present invention;

FIG. 8 is a schematic of an example of a double split-ring resonator suitable for use with the system of the present invention;

FIG. 9 is a schematic showing operation of a metamaterials-based chaotic cavity transducer at a material under test;

FIG. 10 is a schematic showing an array utilizing metamaterials and chaotic cavities;

FIG. 11 is a schematic showing a metamaterial enhanced chaotic cavity transducer with metal slab chaotic cavity;

FIG. 12 is a schematic showing a metamaterial enhanced chaotic cavity transducer with a chaotic cavity utilizing scattering features;

FIG. 13 is another schematic showing a metamaterial enhanced chaotic cavity transducer with a chaotic cavity utilizing scattering features;

FIG. 14 is a schematic showing a metamaterial enhanced chaotic cavity transducer without a chaotic cavity;

FIG. 15 is a metamaterial enhanced chaotic cavity transducer with a chaotic cavity utilizing an acoustic diffuser;

FIG. 16 is a schematic showing responses to an acoustic transducer with three geometric configurations;

FIG. 17 is a schematic showing pre-training a metamaterial enhanced chaotic cavity transducer;

FIG. 18 is another schematic showing pre-training a metamaterial enhanced chaotic cavity transducer;

FIG. 19 is a schematic showing time reversal pre-training method pattern of impacts; and

FIG. 20 is a schematic showing a utilization of metamaterial matching layers.

### DESCRIPTION OF THE PREFERRED EMBODIMENTS

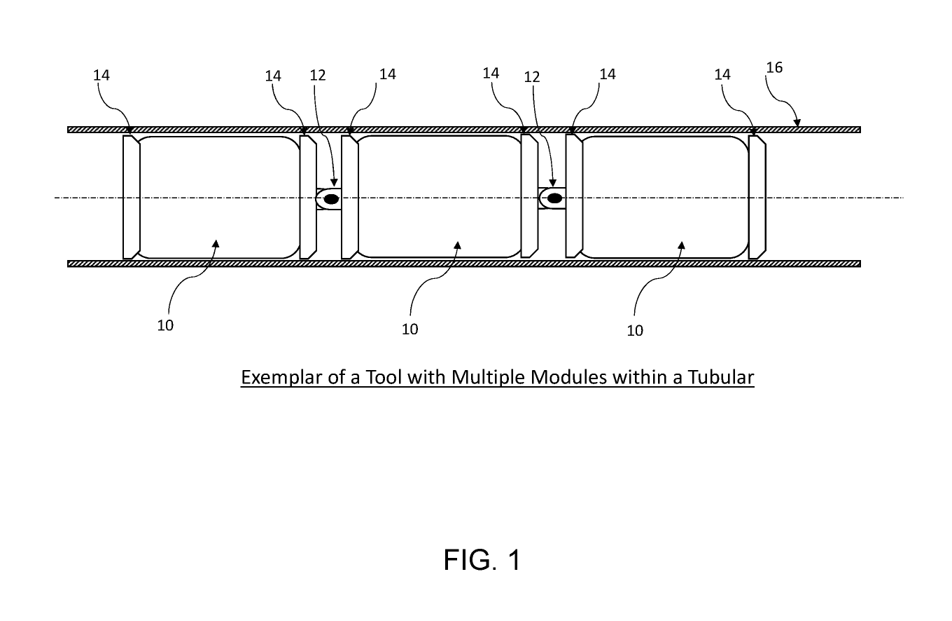

The present invention provides a system and method and apparatus for determining cracks in pipelines or well casings, and other tubulars or conduits. The tool (see, for example, FIGS. 1-3) can be operated in pipelines (such as, for example, for inline inspection), downhole applications (drill strings, well casing and tubing), and other tubulars, or the tool may be moved along an exterior surface of a conduit or tubular or plate or beam or other structure.

The system and method and apparatus utilizes metamaterials to enhance sensing and performance. Metamaterials are largely artificially designed and fabricated materials that are able to achieve effects not found within nature, but sometimes exhibited in nature such as the greatly enhanced colorful visible light reflective patterns of butterflies. Their advantages can be applied in various areas such as acoustic, electromagnetics, magnetics, optics and related imaging and energy intensification/isolation/matching.

Metamaterials are composed of precise man-made material patterns such as holes of varying shapes, sizes, spacing, with or without membranes, and with a single material layer or multiple material layers. Precise implementation is dependent on specific functionality intended in a given application (e.g., focus/energy intensification, broadband impedance matching, cloaking, resolution enhancement, bending, etc.). The materials may comprise a single known material, or a composite material. The materials are used at scales that are typically smaller than the wavelengths of the phenomena they influence. The shape, geometry, size, orientation and arrangement of the metamaterial provides properties capable of manipulating radio frequency, acoustic, light waves and other parts of the electromagnetic spectrum, such as by blocking, absorbing, enhancing, or bending waves, to achieve benefits that go beyond what is possible with conventional materials.

For the purposes of crack detection and characterization, metamaterials can be used to enhance other detection methods employed in the use of acoustic/ultrasonic Vibroacoustic Modulation, magnetics, radio frequency, thermal, light, and other parts of the electromagnetic spectrum. Thus, for example, metamaterials can be used to enhance the detection methods and devices described in U.S. Pat. Nos. 8,797,033 and/or 8,035,374, and/or U.S. patent applications, Ser. No. 15/846,261, filed Dec. 19, 2017, Ser. No. 15/825,312, filed Nov. 29, 2017, Ser. No. 15/652,879, filed Jul. 18, 2017, and/or U.S. Patent Publication No. US-2017-0307500, which are hereby incorporated herein by reference in their entireties.

A metamaterial enhanced chaotic cavity transducer (MMECCT) is an acoustic/ultrasonic (AC/UT) contact or non-contact device composed of one or more source/transducer (or emitter, actuator, transmitter, and the like) for emission and/or one or more detector/sensor/receiver (for response signal energy detection) coupled to multiple passive physical solid state elements/components (chaotic cavity, filter metamaterial, matching metamaterial) integrated in such a way as to produce a significantly enhanced acoustic/ultrasonic source emission and/or enhanced detector signal response due to improved focal spot size and intensity of the resultant energy processing while providing manipulation to achieve control of the location of the concentrated energy to precise points in two-dimensional (2D)/three-dimensional (3D) space in real-time by means of pre-constructed/“pre-trained” time reversal emission profiles stored in digital memory (“pre-training” is an ‘offline’ process conducted before a device is put into operation; when a device is in an operational state it is known as run-time/online). The physical attributes of the physical components and associated methods/processes combine to enhance non-linear features and attributes/responses of anomalous (defect) aspects of a material under test.

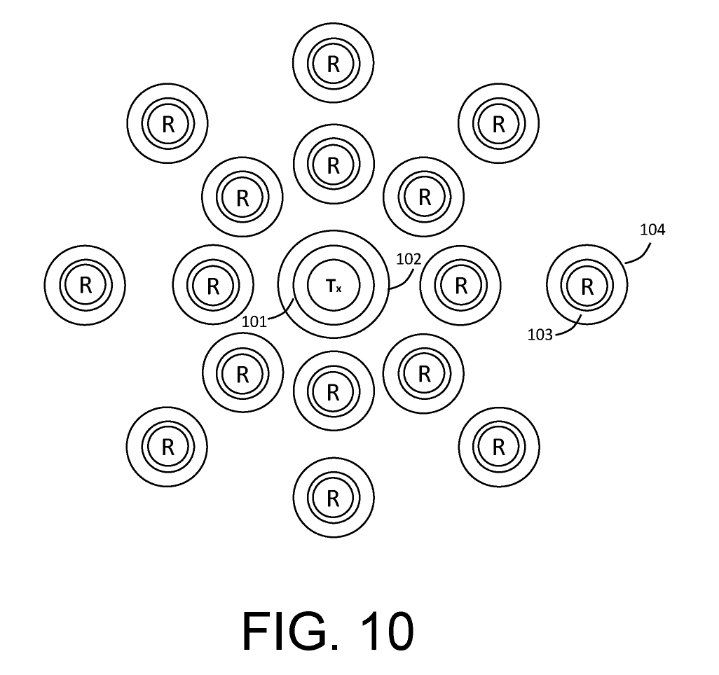

FIG. 10 is illustrative of an array utilizing metamaterials and chaotic cavities. Any number of receivers/detectors/sources may be used, and in any pattern (uniform or not). Any number of transmitters/emitters/sources may be employed. As shown in FIG. 10, the array is comprised of metamaterial transmitters 101 with chaotic cavities 102, metamaterial receivers 103 (with filters) with chaotic cavities 104. Transmitters and receivers may have multiple layers of metamaterials. Any transmitter may also serve as a receiver.

Numerous aspects of acoustic metamaterials provide the means to greatly enhance previously implement acoustic/ultrasonic methods as applied to non-destructive testing (NDT) for detecting anomalous (defect) patterns in various materials. In particular, metamaterials can be utilized to enhance methods based on several central concepts such as the chaotic cavity and time reversal acoustics. Both chaotic cavities and time reversal techniques can be applied synergistically to greatly enhance detectability of defects in NDT applications by optimizing focal point size and energy density when emitting energy as well as providing a means to construct virtual source/emitters and virtual detector/receivers.

In order to achieve a high signal-to-noise ratio, physical chaotic cavities and time reversal acoustics/ultrasonics methods may be employed to improve energy focus and emission intensity of a system designed to detect anomalies in materials. Time reversal methods in conjunction with chaotic cavities (providing complex reverberation patterns) are used to create virtual emission and detection point and direct wave energy to specific scanning points by way of carefully controlled timing in real-time at run-time in a given anomaly (defect) detection process. This process is employed successfully to stimulate anomalies in materials and therefore illicit non-linear responses that are specifically related to the character of undesired features in a material under test.

Fundamentally, the two phase time reversal process (the capability to focus acoustic/ultrasonic waves in time and space—this case aided by the chaotic cavity reverberation patterns) benefits from the concept of the time reversal invariance/reciprocity nature such that non-linear aspects of a given material anomaly (defect) response characteristic can be isolated and refocused with a greater ultimate focus and intensity at the specific anomaly (defect location) than a system that is not employing time reversal principles. Large numbers of transducer sources and sensor/detectors have been deployed in the time reversal process but as the state of the art has progress and time reversal has been employed with chaotic cavities to create the equivalent of a large number of transducer/sensors of a virtual nature thereby reducing the number of “real” physical sensors in the process.

With this basis of related attributes and proven performance of chaotic cavity and time reversal methods as applied to acoustics/ultrasonics, the opportunity for metamaterials and their application in concert with these methodologies is an opportunity to further the state of the art in very well defined ways, which include (but are not limited to): improved AC/UT source/emission focus and energy concentration, enhanced detector/sensor defect signal to noise ratio (weak signal enhancement), and isolation/harvesting important non-linear spectra responses that are more applicable to a given anomalous pattern (defect) in a given material. Additionally, the art is furthered by providing more effective impedance matching between source/emitters and a given material under test, which in turn, further improves the signal to noise ratio of signals composed of anomalous responses (defects). This is accomplished through significantly increased energy transfer from a given source/emitter to the target material under test, thereby reducing attenuation losses that are common in both contact and air coupled acoustic/ultrasonic implementations

Ultimately the goal and outcome of combining chaotic cavity, time reversal acoustics, and metamaterial features is to accomplish the follow objectives (but not limited to these objectives): improved focal spot size and energy density of source/emission, by virtue of above capability implement effective real-time scanning of a given area or volume of a material under test that is more effective due to the generation of smaller and more intense focal spot sizing during energy emission from a source/emitter, smaller and more energy intense focal spot source/emissions result in response signals detected by detector/sensors to exhibit less scattering/clutter that tend to obscure the signal of interest, thereby improving the signal to noise ratio from the material under test.

Additionally, as employed in non-linear acoustics NDT systems as described, metamaterials enable a more effective isolation of the portions of the signal in both time and frequency domain analysis methodologies to enhance elements/components more specifically related to anomalies (defects), while rejecting components related to spurious responses unrelated to a specific anomaly being targeted for detection. As described herein, simplified methods for implementing perfectly matched filters can be integrated into the Metamaterial Enhanced Chaotic Cavity Transducer in a very compact and high performance manner.

Additionally, metamaterials are of a solid state and robust nature typically without troublesome electrical connections often required in other methods to achieve similar functionality. Being of such an inherently reliable form, metamaterials can easily be constructed as modules or blocks such that they can easily attach/detach for simple replacement and in the case customization for various application, quick implementation testing of refinements, or due to advancement in metamaterial technology as just a few of several examples

In general, metamaterials are more fundamentally simpler, more reliable, compact, inexpensive, modular, higher performance, have broader range of real-time functionality, maintainable, upgradeable and so forth, than alternative technologies that are used to obtain similar functionality (such as digital or analog electronic solutions).

### Apparatus:

The MMECCT comprises a chaotic cavity with implementation forms that are highly variable based on the intended application. The MMECCT includes one or more sources/transducers/emitters (these can also act as the detector/receiver as well) attached/inside (or in some close proximity so as to couple acoustic/ultrasonic energy) to a chaotic cavity. The MMECCT also comprises one or more detector/sensors for processing response signals from a source/transducer attached to a chaotic cavity (which can be a common cavity with source/transducers or a separate cavity from the source/transducer cavity).

One or more filter metamaterials are integrated into the physical chaotic cavity to enhance source emission and resultant detector/sensor non-linear return signal responses by achieving an emission of more concentrated energy focus and greater response signal to noise ratios pertaining specifically to the non-linear characteristic of anomalies (defects). Specific response of the associated filters can be employed with directional characteristic in the signal emission/detection paths by way of the design location, geometry, shape etc. of the filter.

One or more layers of impedance matching metamaterials are integrated into the chaotic cavity and filter metamaterial such that impedance mismatch losses between two or more mediums (e.g. air to steel) is greatly reduced, thereby achieving lower energy attenuation and therefore higher focal spot energy intensity and greater response signal to noise ratios in a wide or narrow frequency band manner.

### Methods and Processes:

Use of metamaterials in crack detection systems can provide super-resolution and focusing beyond the diffraction limit. The metamaterials may be configured to control ultrasonic emission focal spot size and energy concentration. Subwavelength enhancement can be a small fraction of fundamental wavelength being emitted (e.g., 1/25th of the frequency being deployed). Also, use of metamaterials in this manner may provide further enhancement of time reversal acoustics principles and/or further enhancement of chaotic cavity principles, such as emission/reception of ultrasonic signals.

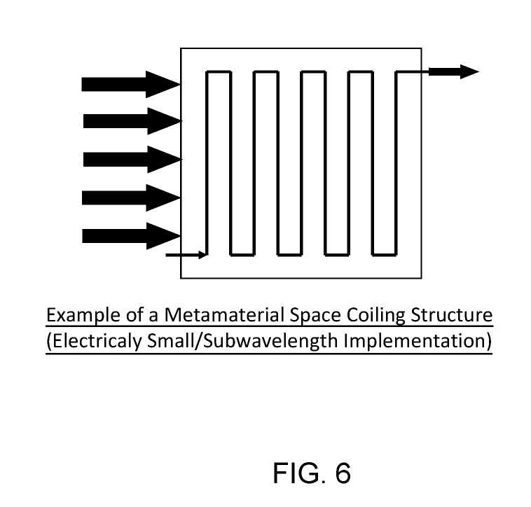

Metamaterials may be used as space-coiling and acoustic metasurfaces. For example, metamaterial benefits can be achieved in compact spaces (acoustically/electrically small implementations) through the use of space-coiling (see FIG. 6). FIG. 6 represents the concept of electrically small/subwavelength size reduction of any given metamaterial implementation such as metamaterial filters, metamaterial impedance matching, etc. This allows smaller sensors and, thus, allows for more sensors/transducers per unit area. Such space-coiling enhances the concept of passive wireless sensor implementations by shrinking size and simultaneously overcoming the challenges of implementing such devices. Use of metamaterials in this manner provides spatially compact sensor systems and allows precise control of wave propagation.

Passive sensors packed more closely together make external wireless power sources easier to implement and interrogate. Metamaterials can be implemented in such a way as to be “electrically small” without losing performance. Therefore, a high concentration of energy coverage in a given area or volume can be provided. Also, tight concentration of energy makes the interrogation of the wireless/passive sensor/transducer devices more effective, since it may then be less complex to encompass multiple sensors in a concentrated radiation pattern of the interrogation beam. By extension, this makes the signal processing chain for multiple sensors less complicated as well, by providing simpler electronics that can utilize a single or a few higher quality and more costly signal chains, versus many low-cost signal chains that require significant replication of signal processing chains. Having fewer signal chains reduces complexity, and allows smaller packaging sizes, etc. An additional advantage is lower power consumption due to the fact that more excitation sources are not required, as well as lower power consumption due to not requiring additional receive channel requirements.

Optionally, the metamaterials may comprise electrically tunable metamaterials, which allow characteristics of the metamaterials to be changed in real time (at run time), and allows for self-adaptation of the metamaterial under control of intelligent algorithms. This approach aids in mitigating or overcoming challenges that can arise as systems change over time (caused by effects of temperature, force, radiation, corrosion or the like), and can be used to overcome deterioration of electronics, sensors, transducers, and the like.

Such an approach also provides possible closed-loop adaptation possibilities, such as bias point control to re-center operational dynamic ranges. The tunable metamaterial may also enhance wireless passive sensor implementations by (i) providing the capability to adapt to specific implementation changes and/or (ii) accommodating on-going upgrades to previous passive wireless sensor implementations as new methods are developed. Such passive and wireless applications may include a block of one or more sensors with no electrical connections and no built-in power source.

Use of metamaterials also provides acoustic absorption, which reduces effects of scattered signals outside of a sensor's field of interest. For example, a metamaterial may be used for cloaking/masking physical sensor areas to reduce ultrasonic signal scattering effect on signal-to-noise ratios. This results in improved signal-to-noise ratios.

Use of metamaterials for acoustic absorption may also reduce effects of scattered signals outside of an emitting transducer's desired radiation field. Also, areas where the signal is to be absorbed will be highly attenuated. An electrically tuned metamaterial absorber can be used for special scanning of areas under test. For example, metamaterials may be used to create a form of virtual phased arrays with one (or a small number of total sensors required). This also applies to emitting transducers.

A sensing system may utilize analog computing in real time with metamaterials. Such a system may be able to perform virtually instantaneous fast Fourier transforms (FFTs) of ultrasonic signals with specialized metamaterials. For example, complex real time filters can be implemented through the use of layered metamaterials (such as matched filters). Characteristics such as computing, filter elements, signal masking, and/or the like can be changed via electrical tuning of the metamaterials. The system may compute focal length changes based on signal patterns, such as by using closed-loop tuning in real time of optimal focus, based on signal processing algorithm(s).

Such a system offers performance parameters that are many orders of magnitude faster than existing analog/digital computers (performing the equivalent at enormously high “gigaflops/watt”—very low power at very high performance). The system may achieve this via use of passive material patterns, which results in increased product reliability as the apparatus is truly a passive solid state device.

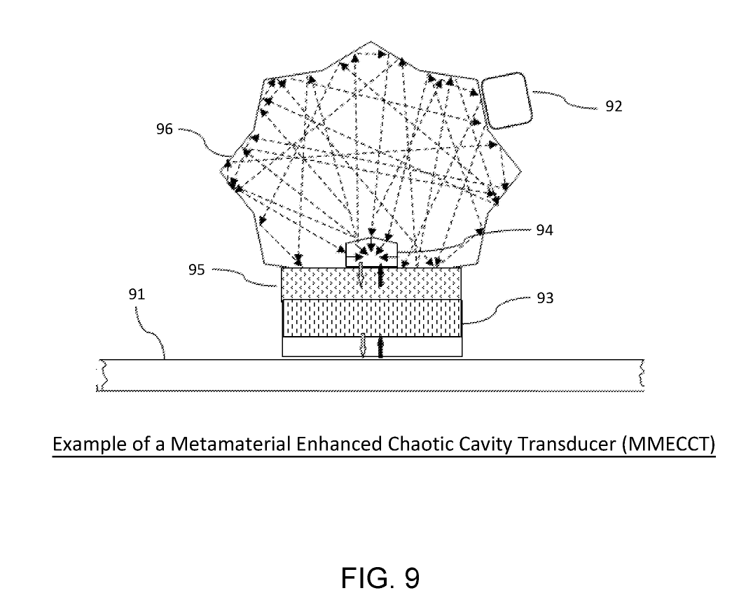

Optionally, a sensing system may utilize metamaterial with chaotic cavity utilizing time reversal methods. Such an application merges the advantages of chaotic cavities with the advantages of metamaterials for real-time filtering, energy concentration, impedance matching, signal masking and the like, all of which results in even further signal-to-noise ratio improvement, which is highly beneficial in air coupled ultrasonic implementations. An example of a metamaterials-based chaotic cavity transducer is shown in FIG. 9.

Such a concept potentially meshes ‘well’ with tunable metamaterials that can adapt in real-time to the characteristics received in a sensor return signal such that a subsequent multi-phase re-emission (excitation) can be optimized in terms of frequency spectra, spatial location, and excitation amplitude as is the case in concentrated ‘local defect resonance’ characteristics of a given crack or crack field. The combined chaotic cavity metamaterial approach also can be used to improve a “pre-trained” time reversal method, where no time reversal is occurring at run time, but rather is trained a priori (offline), such that emission intensification can be enhanced further beyond the simpler time reversal methods employing only a chaotic cavity and time reversal methods or even time reversal with no cavity employed.

Thus, genetic programming, genetic algorithms, particle swarm optimization and other related machine learning and artificial intelligence methods including combinations of these methods (and other numerical methods) can be used to determine an optimized metamaterial configuration. This allows for manipulation, control, and enhanced focus, impedance matching, absorption, reflection, isolation, and damping of acoustic waves, electromagnetic waves, magnetic fields, thermal transfer, mechanical, and optics.

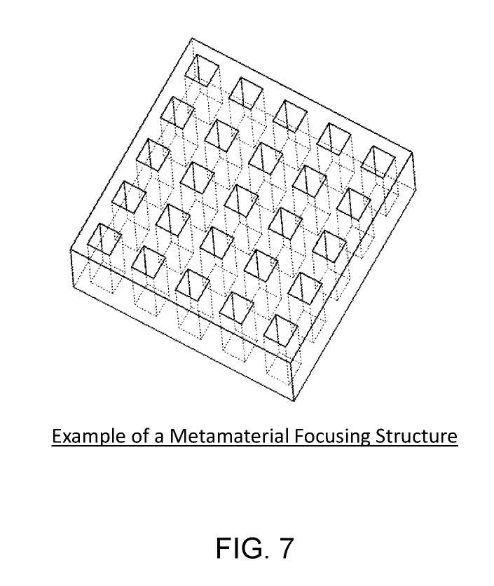

Metamaterials can be used to enhance other detection methods such as Vibroacoustic Modulation and Impedance Methods. Such applications of metamaterials can provide improved focus/energy concentration, and a superior impedance match for air coupled implementations. An example of a metamaterial focusing structure is shown in FIG. 7. Such applications of metamaterials also provide the possibility of tomographic ‘cuts/slices/sections’ stripping layers of material to reduce effective attenuation.

Use of metamaterials in such sensing systems also provides increased imaging effects (such as focus concentration and energy intensification) and image resolution associated with subwavelength image enhancement phenomena, extraordinary transmission (such as extraordinary acoustic transmission). The use of metamaterials also provides for enhancement of transducer/sensors that are constructed in such a way as to be passive with no inherent ‘built in’ power source or directly wired connections, but are ‘powered’ remotely with respect to the transducer/sensor for the purpose of energy emission and/or signal energy reception (concepts known as “passive wireless” methods). Metamaterials can be used to convert an already very intense conventional emission source into an extraordinary emission source, which could greatly reduce the total energy required to emit key frequencies and amplitudes related to crack characteristics—thus making for effective crack detection and greatly lowering excitation power (and thus extending battery life as well as lowering power dissipation, opening up the possibility for smaller package implementations with less thermal challenges).

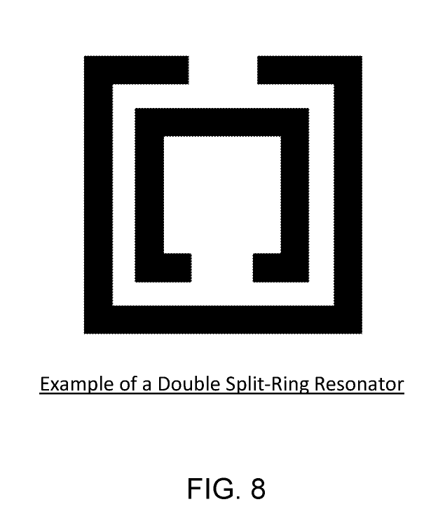

The present invention utilizes metamaterials for a crack detection system. Metamaterials can be constructed of various materials and determined (geometric, spatial, and otherwise) configurations—including the usage of 3-D printing (i.e., artificially fabricated materials). Such metamaterials can be used in connection with a variety of sensing systems or devices, such as GMI, GMR, AMR, SQUID-Detector, along with other forms of highly sensitive, low noise magnetic sensor technologies such as phonon traps, etc. Use of metamaterials also provides split-ring resonators (see FIG. 8) with subwavelength slit enhancement.

In accordance with the present invention, metamaterials may be used in connection with ultrasonic emitters (such as in the case of extraordinary emissions of great energy concentration and intensity) and/or ultrasonic emitters such as the case of providing broadband impedance matching for enhanced penetration of a material under test. Use of metamaterials also provides ultrasonic sensor enhancement such as sensitivity enhancement by way of aperture control, frequency filtering, resolution, acoustic diode actions, and real time computation of operations such as fast Fourier transforms.

Metamaterial devices of the above categories can be dynamically modified by way of real time electronic tuning methods. And metamaterials may be constructed in one or more layers with specifically tailored characteristics.

### Time Reversal:

In accordance with the present invention, a time reversal acoustic/ultrasonic method may be used by which a multitude of spatially concentrated focal spots are generated in 2D/3D space such that the ‘offline’ (pre-operation of the tool) pre-trained time reversed attributes of these focal spots can be reproduced at the same precise locations at run-time in real-time in a simplified manner due to the pre-training re-emission time series attributes being stored in digital memory.

Time reversal pre-training provides substantial benefits of time reversal acoustics/ultrasonics without the need to execute the time reversal process completely at run-time (online). In the short time windows available for certain real-time applications (such as in the case of a physically fast moving system) only tens or hundreds of microseconds are available for signal generation and return signal processing; therefore, performing time reversal acoustics in these time frames tends to be very impractical and/or expensive to implement. Time reversal pre-training is a method to overcome this limitation and enable time reversal benefits in extreme real-time cases. Such short processing time windows occur when a given detection systems is moving at a fast velocity relative to one another or a material is moving rapidly relative a detection system or both the detection system and the material are in motion relative to one another.

By virtue of the time reversal pre-training process, in conjunction with the other components of the MMECCT, one or more small numbers of source and detector can perform functionally like a physical phased array transducer composed of large numbers of physical transducers with significant reduction in complexity, size, cost, improved reliability, and maintainability. This simplified replications of the features of a complex physical multi-transducer/sensor phased array is known as a “virtual phased array” (VPA) although the method used in its implementation in this context differs from the typical means used to implement a virtual phased arrays therefore heretofore will be referred to as “Simplified Pre-trained Virtual Phased Array” (SPVPA) designating that its attributes are established at ‘training time’ (aka offline) as opposed to achieving the virtual phased control through complex and computationally intense timing control at run-time (online). Historically implemented virtual phased arrays will be referred to as “complex virtual phased array” (CVPA) because of the relatively high complexity of implementation due to the real-time algorithm required to control and produce the needed results.

### Basic Operation of MMECCT

### Excitation Sequence:

Excitation/emission originates from one or more source/transducers/emitters (emitting patterns that were generated in the offline pre-training process) coupled to the chaotic cavity. The signal reverberates in the chaotic cavity producing a virtual emitter points (optionally, a diffuser or other scattering features may be used to further scatter in a more complex manner). The virtual emitter points are then filtered via metamaterial(s) in-line with the energy emission path. The filtered virtual emitter points are then passed through the impedance matching metamaterial(s). Ultimately, the intensified focused energy impinges on the material under test (such as a tubular).

### Response Signal Sequence Option (Pulse-Echo Method):

In one aspect of the invention, the response signals produced as a result of the aforementioned excitation sequence are reflected from anomalous/defect features (such as a crack) of the material under test (such as a tubular) back to the entry area of the MMECCT device. The response signal then enters the impedance matching metamaterial of the MMECCT device, which increases the efficiency of the energy transfer. The response signal then enters metamaterial filter(s) of the MMECCT device, which accentuates the non-linear aspects of the anomaly/defect signals. The response signal then enters the chaotic cavity where multiple virtual sensor points compositely return to the source/transducer/emitter (which is now acting as a receiver/detector). The complex signal patterns impinging on the source/transducer emitter acting as a receiver/detector are now passed on to the signal processing chain.

In another aspect of the invention, the source/transducer/emitter is also used as a receiver/detector, and this would be a pulse-echo method (typically, this would be within a single MMECCT device—with one or more of these devices used on a tool).

### Response Signal Sequence Option (Pitch-Catch Method):

In one aspect of the invention, the response signals produced as a result of the aforementioned excitation sequence are reflected from anomalous/defect features (such as a crack) of the material under test (such as a tubular) to the entry area of separate receiving/detecting MMECCT device(s). The response signal then enters the impedance matching metamaterial of the receiving/detecting MMECCT device(s)—increasing the efficiency of the energy transfer. The response signal then enters metamaterial filter(s) of the receiving/detecting MMECCT device(s)—accentuating the non-linear aspects of the anomaly/defect signals. The response signal then enters the chaotic cavity where multiple virtual sensor points compositely return to the receiver/detector/sensor. The complex signal patterns impinging on the receiver/detector/sensor are now passed on to the signal processing chain.

In accordance with another aspect of the present invention, if (one or more) source/transducer/emitter and (one or more) receiver/detector are used, this would be a pitch-catch method.

In combination the features of the MMECCT are deployed to produce AC/UT energy of a very small and intense focal spot size that can be steered in real-time to precise points in 2D/3D dimensional space through a process of time reversal ‘pre-training’. All the elements and processes of the MMECCT re-enforce the ultimate objectives of intense energy focus in a concentrated manner to achieve the optimized non-linear response of material anomalies (defects) and do so with control of the precise location that this energy can be steered in 2D/3D space.

### Filter Metamaterial

In accordance with an aspect of the present invention, the invention enables the capability to customize the integrated metamaterial filters for more efficient stimulation and processing of non-linear characteristics of material anomalies, by virtue of band reject, band pass, and matched filter implementation optimized to detect non-linear features and do so in real-time with distinct advantages over other alternate filtering methods such as electronic digital and analog signal processing filters. Several specific metamaterial filter advantages over alternative methods exist. For example, no external power source is required as in the case of digital and analog filters. Metamaterial filters require no power consumption and therefore require no associated heat dissipation. Metamaterial filters are more compact and modular. For example, snap in blocks for integration. Therefore, metamaterial filters are very conducive to maintenance, upgrade, repair; and re-use. Metamaterial filters may alternately be produced as a unified single component depending on application objectives. Metamaterial filters may be very rugged and reliable with very low cost of production and, for example, can be constructed electrically small as fractional wavelength sizes without losing performance effectiveness (such as in the method termed “coiling up space”).

Metamaterial filters can also, for example, be constructed employing various forms of phononic ultrasonic crystals utilizing bandgap characteristics to form frequency filtering customization for a given application. Novel metamaterial filter implementations may also, for example, be constructed through selection and combinations of filter material constructed through use of selection of number and configuration of channels, shapes, and periodic spacing. Metamaterial filters provide a rich diversity of complex variations of solutions that can be generated through use of multi-physics modeling/simulation environments such as COMSOL Multiphysics (analytical software) coupled via an application programming interface such that a given model can be manipulated to converge on a solution through the use machine learning, genetic algorithms, genetic programming, particle swarm optimization and so forth. Existing metamaterial filter designs can be used by such an approach to act as a starting point to be manipulated by such intelligent discovery methods based on the goals and parameter constraints dictating the iterative refinement of the final metamaterial ultimate optimized outcome to meet the needs of the application case specified.

### Impedance Matching Metamaterial

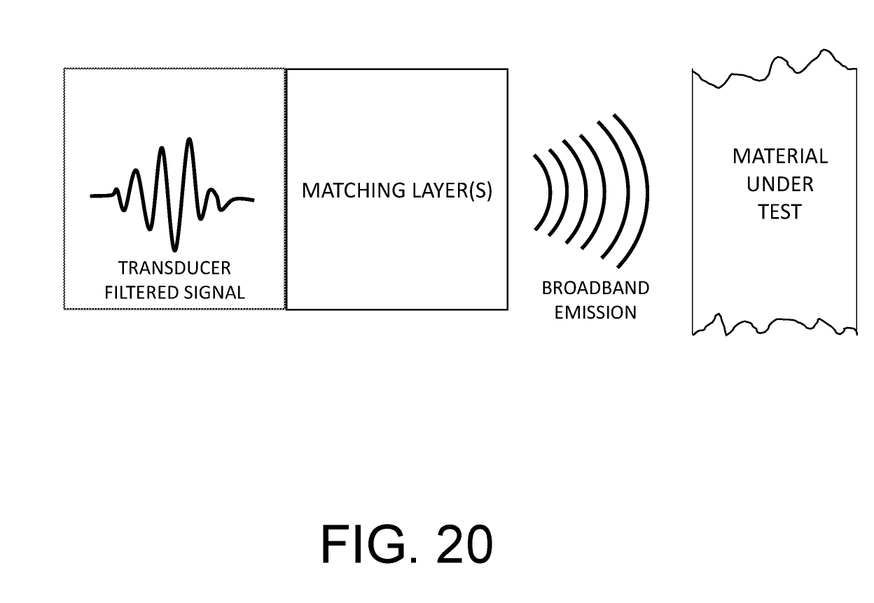

In one aspect, the present invention enables the capability to customize the integrated impedance matching filters for more efficient stimulation and processing of non-linear characteristics of material anomalies, by virtue of overcoming significant attenuation losses due to such impedance mismatch, implementation optimized to detect non-linear features and do so in real-time with distinct advantages over other alternate matching methods such as electronic digital and analog signal processing matching schemes that have inferior and complex forms compared to a matching metamaterial with close spatial proximity to the material under test (see FIG. 20). Specific impedance matching metamaterial provide many advantages over alternative methods. For example, no external power source is required as in the case of greatly inferior performance digital and analog impedance matching networks. Metamaterials also provide almost unlimited possibilities for improving impedance matching performance and do so in either a single frequencies form or wide-band frequency form without adding significant volume and size for given application. Therefore, the total size of implementation does not grow significantly with improved matching capability (unlike electronic version equivalents). Improved matching improves focal spot size and energy concentration and therefore return response with improved signal to noise ratios.

Such metamaterials also exhibit no power consumption and therefore require no associated heat dissipation. They are more compact and modular as, for example, snap in blocks for integration, and therefore very conducive to maintenance, upgrade, repair, and re-use. Metamaterials may alternately be produced as a unified single component depending on application objectives. Such filters are also very rugged and reliable with a very low cost of production. Impedance matching metamaterial can, for example, be constructed electrically small as fractional wavelength sizes without losing performance effectiveness (such as in the method termed “coiling up space”). Impedance matching metamaterial can also, for example, be constructed employing various forms of ultrasonic complementary metamaterials. Novel impedance matching metamaterial implementations can also, for example, be constructed through selection and combinations of gradient methods to provide characteristics enabling smooth impedance matching transition from one medium to another.

A rich diversity of complex variations of impedance matching metamaterial solutions may be generated through use of multi-physics modeling/simulation environments such as COMSOL Multiphysics (analytical software) coupled via an application programming interface such that a given model can be manipulated to converge on a solution through the use machine learning, genetic algorithms, genetic programming, particle swarm optimization and so forth. Existing impedance matching designs can be used by such an approach to act as a starting point to be manipulated by such intelligent discovery methods based on the goals and parameter constraints dictating the iterative refinement of the final metamaterial ultimate optimized outcome to meet the needs of the application case specified.

### Chaotic Cavity

In one aspect of the invention, a chaotic cavity using metamaterials enables the capability to customize the size, shape, and form of the chaotic cavity for almost infinite virtual source emission and/or detector/sensor points. In conjunction with time reversal AC/UT methods, time domain and frequency domain characteristics of the overall MMECCT can be optimized with very few constraints to stimulate optimized non-linear signal responses related to material anomalies/defects. In conjunction with pre-training time reversal methods, the MMECCT achieve all the attributes of a complex physical multi-sensor phased array. This provides many advantages. For example, a small number of physical sensors is required, cost of implementation is lowered, implementation size is reduced, higher reliability is provided, and simplified scanning of spatial control steering of focal spot energy emission by way of pre-trained time reversal process.

Additionally, a chaotic cavity aided by metamaterials is more compact and modular as snap in blocks for integration, therefore very conducive to maintenance, upgrade, repair, and re-use. They may be alternately produced as a unified single component depending on application objectives and are highly customizable in terms of size, shape, form, material etc., producing rich possibilities of diversity of scattering patterns which improves virtual transducer source/detector sensor effectiveness.

In conjunction with integrated metamaterial filter and metamaterial impedance matching elements, the chaotic cavity can be customized to interconnect in virtually unlimited ways to accommodate size, orientation, combinations of one or more large numbers of MMECCT transducers with the added possibility of making the MMECCT devices of a sub-wavelength or electrically small nature, lending itself to extreme miniaturization, often an order of magnitude (or more) smaller than non-sub-wavelength sizes, as previously implemented based on classical physics principles.

### Diffuser

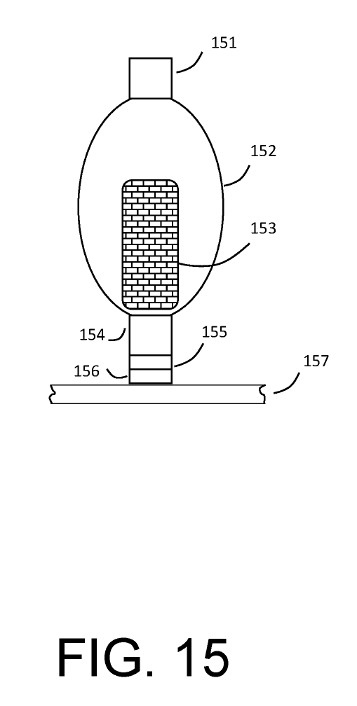

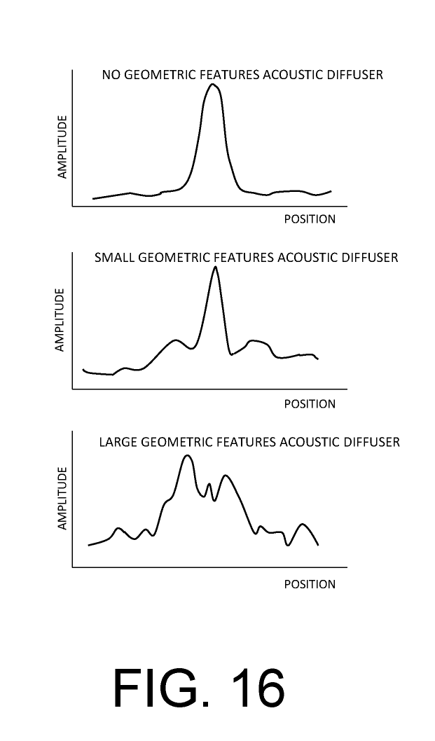

In accordance with an aspect of the present invention, MMECCT can be further enhanced in the chaotic cavity component/element through the use of what is known as an acoustic/ultrasonic diffuser (also called a “leaky cavity” and an “intentional scatterer”). As with other MMECCT integrated components, acoustic/ultrasonic diffusers are inserted in or attached to the associated chaotic cavity. Functionally, the deployment of such a material further enhances complex random surface reflections that lead to improved energy focusing quality in time and space via the time reversal process. This, in effect, increases the complexity of reflective surfaces via AC/UT diffusion and creates additional populations of virtual emitters and sensors ultimately leading to improved signal to noise ratios for detecting anomalies/defects (see FIG. 15 and FIG. 16). AC/UT components/elements can be placed in or on a chaotic cavity in various shapes, locations, etc. in a signal path to optimize its intended use. Design variations of diffusion elements can affect energy focusing intensity, signal frequency band response etc. Diffusion elements/components can be composed of random terrains and forms of various diffusion material combinations of various lengths and sizes to produce diffusion patterns depending on the application requirements. Forms and placements of diffusion materials can be constructed in many manners to optimize the implementation for any given application.

Cumulatively an AC/UT diffusion component/element or components/elements, along with metamaterial filters and metamaterial impedance matching elements coupled and utilized with the process of time reversal AC/UT methods leads to incrementally more effective emission/detection enhancement that further improves the detection capability of anomalous/defect in materials under test.

As shown in FIG. 15, a chaotic cavity 152 is disposed at a transducer 151. An acoustic diffuser 153 is disposed on or within chaotic cavity 152. A metamaterial filter 154 includes a first multilayer impedance matching metamaterial 155 and a second multilayer impedance matching metamaterial 156 disposed on or near tubular or any material under test 157. The use of a diffuser can be deployed in diverse configurations to tailor specific frequency response and time domain response characteristics. FIG. 15 is an example of just one of many possible configurations.

### Time Reversal Pre-trained/Virtual Phased Array

In accordance with an aspect of the invention, time reversal using a pre-trained/virtual phased array enables the capability to effectively perform control in 2D/3D space of intensely focused AC/UT energy through time reversal pre-training process resulting in a greatly simplified steering mechanism implementation in real-time. This steering mechanism in conjunction with the elements of the MMECCT provide the benefits of a physical multi-sensor phased array with many advantages. For example, a greatly simplified control of spatial point generation in 2D/3D space is achieved by pre-training at training time (offline) but launched in normal operation at run-time. Also, a smaller number of physical sensors is required, a lowered cost of implementation is achieved, and a smaller overall size of implementation is realized. Additionally, higher reliability is achieved, and it simplifies scanning of spatial control steering of focal spot energy emission by way of pre-trained time reversal process. This mechanism also allows for more compact and modular as snap in blocks for integration, therefore is very conducive to maintenance, upgrade, repair, and re-use. This mechanism may be alternately produced as a unified single component depending on application objectives and is highly customizable in terms of size, shape, form, material etc., which produces rich possibilities of diversity of scattering patterns which improves virtual transducer performance.

### Metamaterial Integration

The integration of the attributes of chaotic cavities and time reversal acoustic together with metamaterial features specifically involves the addition of two metamaterial types. First, metamaterial frequency spectrum filters (bandpass and band reject/notch filter) have a specific response that can be employed with directional characteristics in the signal emission/detection paths by way of the design location, geometry, shape etc. of the filter. Second, metamaterial impedance matching layers with broadband characteristics allows for specific response that can be employed with directional characteristic in the signal emission/detection paths by way of the design location, geometry, shape etc. of the filter.

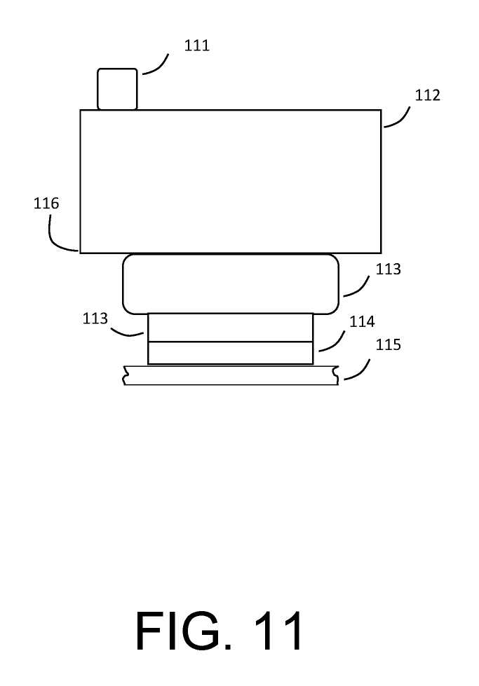

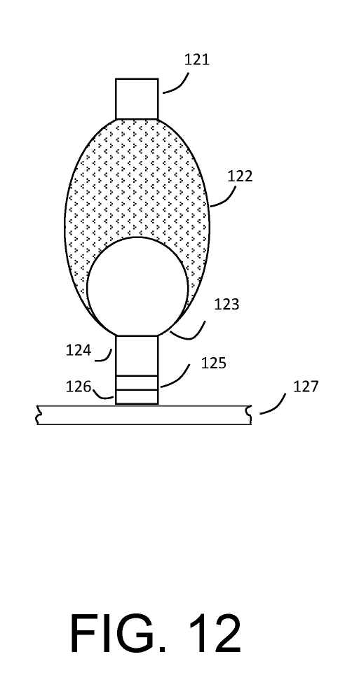

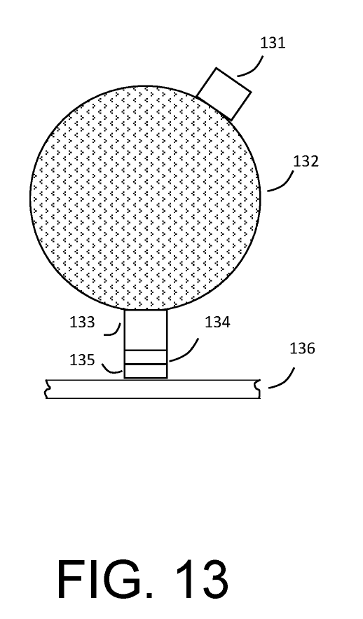

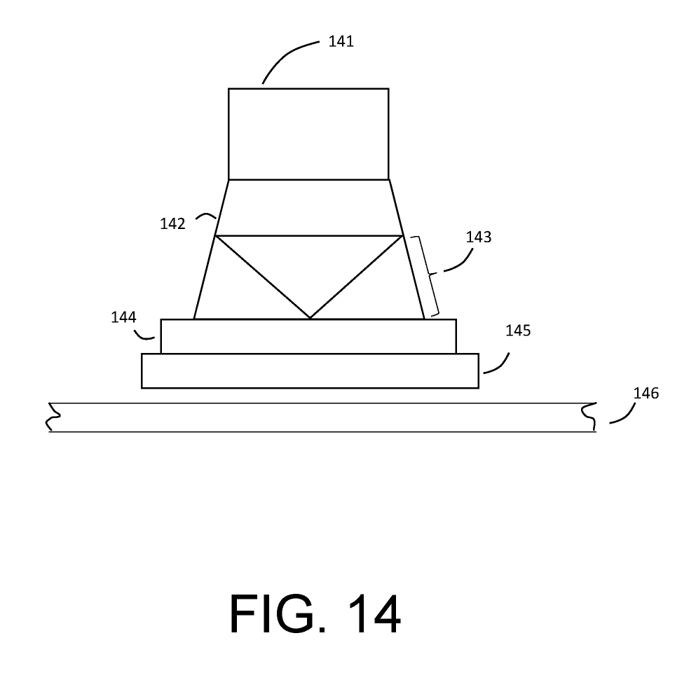

Referring now to the figures, FIG. 9 shows as example of a metamaterial enhanced chaotic cavity transducer. As shown in FIG. 9, the transducer 92 uses the chaotic cavity 96, a first metamaterial filter structure 94, a second metamaterial filter structure 95, and metamaterial impedance matching structure 93 to detect cracks in tubular or material under test 91. The chaotic cavity 96 is used to emulate a multi-sensor and/or multi-emissions source to improve time reversal focus and/or energy concentration and return signal to noise ratio improvement. FIG. 10 is an example of a MMECCT with a metal slab chaotic cavity, as discussed above. As shown in FIG. 11, a transducer 111 uses a chaotic cavity 112 which has a slab surface 116, a metamaterial filter structure 113, and a metamaterial impedance matching structure 114 to detect cracks in the tubular or material under test 115. FIG. 12 is an example of a MMECCT with a chaotic cavity utilizing scattering features. As shown in FIG. 12, a transducer 121 uses a chaotic cavity with scattering features 122, a first metamaterial filter structure 123, a second metamaterial filter structure 124, a first metamaterial impedance matching structure 125, and a second metamaterial impedance matching structure 126 to detect cracks in the tubular or material under test 127. FIG. 13 is another example of an MMECCT with a chaotic cavity utilizing scattering features. As shown in FIG. 13, a transducer 131 uses a chaotic cavity with scattering features 132, a first metamaterial filter structure 133, a second metamaterial filter structure 134, and a metamaterial impedance matching structure 135 to detect cracks in the tubular or material under test 136. According to an aspect of the invention, a MMECCT technique may be used without a chaotic cavity. As shown in FIG. 14, a transducer 141 uses region of acute divergence from an emitting source 142, focusing metamaterial layers 143, steering metamaterial layers 144, and multilayer impedance matching metamaterial 145 to detect cracks in the tubular or material under test 146.

The integration for the metamaterial frequency filters and impedance matching metamaterials in the implementation of the “Metamaterial Enhanced Chaotic Cavity Transducer” provides specific functions based on the source/emission and detection/sensing aspect of this device.

Firstly, one or more integrated notch (band reject) filter is employed in the device signal path such that detectors/sensor defect signals are not “contaminated” with low frequency pump energy, which would tend to overload signal processing channels and blind the detection process, ‘swamping out’ the defect related ‘signal of interest’. Such low frequency pump energy can be generated in a number of manners including (but not limited to): frequency sweeps, frequency sweeps with modulated amplitudes, pulsed broadband/wideband energy emissions, digital binary, trinary, ternary pulse compression and so forth. Such low frequency emissions serve to stimulate defects such that the defects are set in motion (modulated by way of clapping, stick/slip motions etc.) thereby elucidating their presence for easier detection by a high probe signal frequency that mixes in various complex manners with the low frequency pump signal. Ultimately the low frequency filter rejects the pump related component so that the probe frequency can be more effectively evaluated, since it carries more information pertaining to the nonlinear characteristic of the anomaly (defect). Such low frequency filtering can be accomplished by other methods than metamaterials but do not provide the above cited attributes of a metamaterial filter.

Secondly, one or more integrated high frequency bandpass filter, matched filter etc., is employed in the device signal path such that detectors/sensor defect signals of a non-linear response nature are passed freely to the detection system. These high frequency signals more completely reflect the characteristics of any anomalies (defects) that are present in the material under test. Once again, this high frequency bandpass filter, matched filter etc. is integrated into the “Metamaterial Enhanced Chaotic Cavity Transducer” (as in the case of the low frequency band reject metamaterial filter) with all the corresponding attributes cited previously.

Thirdly, one or more integrated single layer multi-layer broad-band/wide-band or narrow-band (or combinations of various frequency band combinations) impedance matching metamaterial is integrated into the signal emission/processing path of the “Metamaterial Enhanced Chaotic Cavity Transducer”. Multiple layers (or single layer) are employed in this metamaterial impedance matching scheme to achieve a broadened match over a wide frequency range corresponding (or a more narrowband resonant matching implementation), in particular to a low frequency pump excitation frequency range. In particular, this impedance matching metamaterial scheme allows more intense level of energy to be coupled from the source/emitter to the material under test, to stimulate a more intense signal response from a given anomaly (defect). As previously cited, this metamaterial enhances the energy density of the emitted energy in the focal spot region such that the energy transfer to a given anomalous (defect) feature responds more ‘decisively’. The impedance mismatch when acoustic energy travels from one materials such as a source emitter transducer through air to a target material such as metal causes a great loss of energy. The cited layers (or single layer typical in the narrowband case) of metamaterial not only reduce the effects of this impedance mismatch in general, but due to the multilayered approach do so over a broad frequency range (a single layer of impedance matching metamaterial would typically work only over a very narrow region due to its single frequency resonance nature).

### Local Defect Resonance

The capability for a multi-layered broad band/wide band impedance matching metamaterial and associated metamaterials frequency filters to enhance emission characteristics in the form of higher energy density in the focal spot generated by the MMECCT is very important due to the well-established phenomenon known as the “local defect resonance” (LDR) anomaly/defect related response. This is an enhanced anomaly/defect response that occurs when energy from a source/emitter is produced in a broadband/wideband manner such that either the direct emission frequencies or harmonics or sub-harmonics of the emission broadband/wideband frequencies are emitted such that the anomaly's (defect's) local defect resonance frequency is produced. When energy is at a given anomaly's LDR, significantly lower energy is required to stimulate modulation/motion of the given anomaly (defect) by an estimated 20-40 db or more enhancement magnitude over a non-LDR frequency impinging on a given anomaly. Synergistically, the impedance matching metamaterials, filter metamaterials, chaotic cavity, and time reversal methods all work together to enhance the wide-band emission and corresponding response of a given anomaly (defect) in a material under test by way of its local defect resonance response.

### Simplified Pre-trained Virtual Phased Array (SPVPA)

Considering the above mentioned complementary integration of filter and impedance matching metamaterials, chaotic cavity, and time reversal methods, the extended use of Metamaterial Enhanced Chaotic Transducer is to be the basis for a high performance ‘virtual phased array’ device.

A virtual phased array is an implementation of multiple virtual source-emitters/detector-sensors made possible by reflections and reverberations within a chaotic cavity produced in conjunction with a single (or small number) source/emitter (or detector/sensor for response signal purposes). Therefore, a single or small number of source/emitter—detector/sensors performs as if a large multitude of real physical sensors were present as in the case of “phased arrays”. In the case of physical phased arrays a given pattern of radiation (wave directionality) can be controlled by way of signal generation strategies (such as relative delays in excitation energy being applied to each individual source/detector) in real time at runtime (online) allowing a particular area/volume to be scanned in simple raster patterns or any arbitrarily chosen pattern depending on the application requirements. The motivation to emulate the capability of a multi-sensor phased array with a virtual phased array are numerous.

For example, virtual phased arrays are much less challenging to implement a high-performance material anomaly (defect) system that can process associated characteristics in real-time. Additionally, because of the reduced number of source/emitters the associated drive and signal processing electronics requirements and related complexity are greatly reduced. This reduction of complexity in the case of virtual phased arrays makes the overall system simpler, smaller, more energy efficient, less costly, easier to maintain, and easier to upgrade than physical multi-sensor phased arrays.

The present invention includes novel methods whereby simplified pre-trained virtual phased arrays can be implemented in such a way so as to simplify the means by which wave directionality of source/emitter can be spatially controlled at run-time launch so as to mimic the steering capability of the physical multi-sensory phased array.

This novel method of wave directionality and scanning of a given area or volume as it applies to contact and non-contact source/emitters to yield a large number of virtual transducer/sensor points for acoustic/ultrasonic source/emission or detection/sensing is discussed in more detail below.

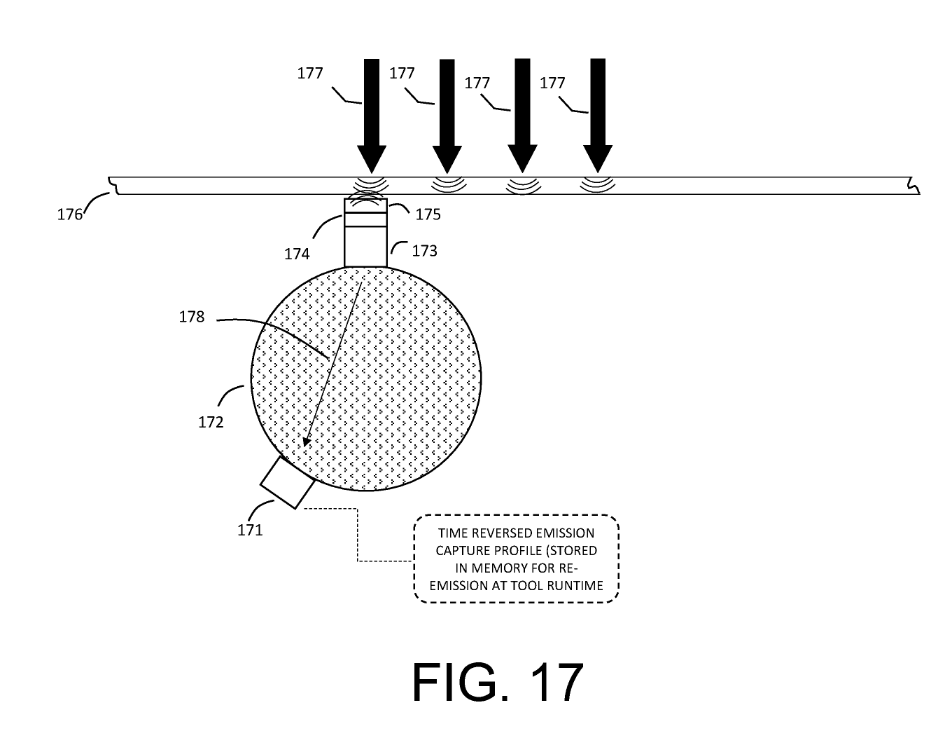

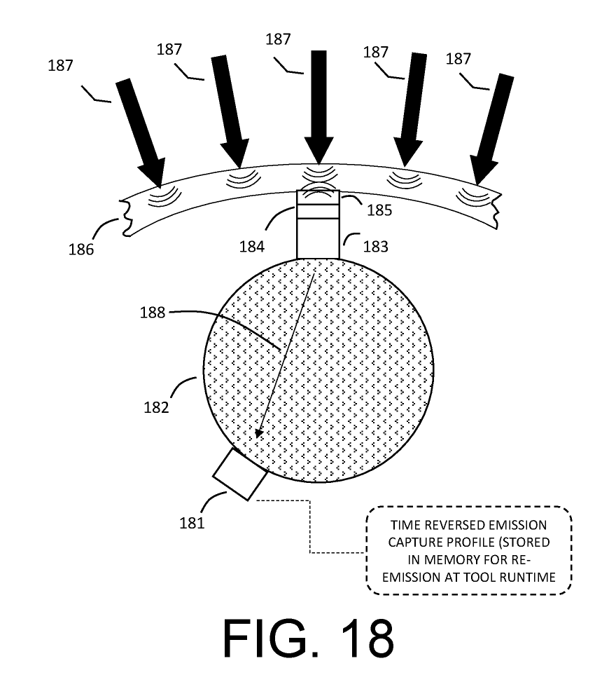

The method for controlling a simplified pre-trained virtual phased array (SPVPA) so as to perform wave directionality control (for scanning purposes) is accomplished by means of the following methods (see FIGS. 17-18). It should be understood that this is a slow iterative process that is not accomplished without time consuming iterative cycles—the tradeoff is a simplified faster execution of time reversal scanning/focusing benefits at run-time/online.

FIG. 17 provides an example of time reversal pre-training (pre-operation of tool). As shown in FIG. 17, a transducer 171 with a chaotic cavity with optional scattering features 172, a first metamaterial filter 173, a second metamaterial filter 174, and a multilayer impedance matching metamaterial 175 is placed on or near the tubular or material under test 176. Planned external impacts 177 are then applied to the tubular 176. The planned impacts 177 for time reversal pre-training can be in any pattern (uniform or non-uniform), and can be one or more at a time. The system senses the tubular during the impacts to pre-train the tool, as discussed below.

FIG. 18 provides another example of time reversal pre-training (pre-operation of tool). As shown in FIG. 18, a transducer 181 with a chaotic cavity with optional scattering features 182, a first metamaterial filter 183, a second metamaterial filter 184, and multilayer impedance matching metamaterial 185 is placed on or near the tubular or material under test 186. Planned external impacts 187 are then applied to the tubular 186. The planned impacts 187 for time reversal pre-training can be in any pattern (uniform or non-uniform), and can be one or more at a time. The system senses the tubular during the impacts to pre-train the tool, as discussed below.

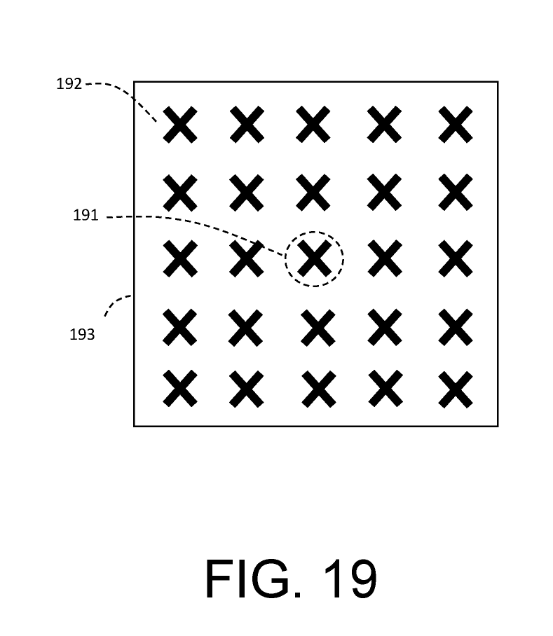

FIG. 19 provides an example of time reversal pre-training method pattern of impacts. As shown in FIG. 19, a MMECCT 191 is located on an inner wall of the material under test 193 and external impacts 192 are applied to the material under test 193.

During an offline (pre-training time) session, a means is provided to impart concentrated energy (an intense emission/perturbation) to a given material to be tested. This emission/perturbation source would be in a form such as a mechanical device (mechanical actuator, hammer and punch, piezo actuator, acoustic transducer coupled to a focusing device such as an ellipsoid cavity, laser beam and so forth) as part of an offline training or pre-training process (this process is called “pre-training” to contrast this method with the typical time reversal training process that is performed at run-time and therefore is a more complex and time constrained real-time process. In addition, it is difficult to perform real-time time reversal in short time frame processing windows in faster acoustic/ultrasonic systems).

The purpose of such an energy impulse perturbation (excitation/emission) being produced in a concentrated manner is to allow the integrated Metamaterial Enhanced Chaotic Cavity Transducer (which is attached to the ‘defect free’ material under test that is being perturbed with the above mentioned method to impart a large impulse of concentrated energy in particular when it is employed with an optimized excitation method such as various pulse compression techniques, exactly solvable chaos etc.) to receive this energy impulse response with the objective of storing the response signal characteristics (by means of an analog to digital conversion being deployed to capture this pattern that is then stored in digital memory).

This stored pattern (which is utilized as an emission source pattern at run-time, emitted by means of a digital or analog power amplifier/driver of a source/transducer attached a as component of MMECCT) represents the response from related defect free material being perturbed (energy imparted to defect free sample) with the signal being processed by way to the Metamaterial Enhanced Chaotic Cavity Transducer processing this response.

Typically, the perturbation source that produces this concentrated energy would be designed to impart to the defect free material under test not only a predetermined magnitude of energy but also a predefined frequency spectrum of energy (which could be a continuous source, pulse, chaotic oscillator, and any number of source/emitters) which could be emitted in a broadband or narrowband at a low frequency(s) (pump) and/or higher frequency(s) probe spectra realm, or some combination of two or more bands of frequencies so that nonlinear anomalies (defects) present in material would cause harmonic responses and non-linear frequency mixing responses from a compromised abnormal material.

This entire pre-training time reversal process is performed on typical defect free materials and is performed with the material used for the pre-training process and the MMECCT (place opposite the side of the material where the perturbation is being produced or depending on the application requirements, the same side of the material) all stationary. The perturbation source is moved in small increments to produce spatial separation of the emission points (perturbation/excitation) which later translates (at runtime) into the specific effective scanning point emissions incrementally produced in real-time.

The reason defect free material is employed in the pre-training tie reversal process is due to the fact that the system is being pre-trained to produce energy on the outer far side wall of the material (or on the near side material well, depending on requirements of the application), where the effective high concentration of energy is best emitted at runtime to produce optimal energy for detecting far side/near side material anomalies (defects), which tend to be the most difficult form of anomalies (defects) to detect in a material in real-time.

Defect free material is employed for pre-training so that no non-linearities are present so that an uncontaminated anomaly/defect free focal spot of high energy concentration can be produced on a far or near side surface where most challenging material anomalies/defects need to be detected. At run-time when such concentrated focused high energy impinges on an anomaly/defect related non-linearities are produced which leads to detection.

An additional process option for the pre-training of any given perturbed point is to record the response to multiple cycles of perturbations and average the composite response to then be stored as a single point profile (after being time reversed). The composite time reversed response would be stored in digital memory for later re-emission of the corresponding run-time time series source/emission/perturbation pattern for that single point. This multiple perturbation and averaging scheme would of course be used for each spatially separated point, as previously mentioned.

Once this initial response pattern (resulting from a given point perturbation) is stored in memory it then is utilized for the time reversal processes, which involves the normalization of the response signal, the reversal of the signals received order in memory, and then ultimately the “re-emission” of the signal from the Metamaterial Enhanced Chaotic Cavity Transducer back in the direction of the material under test. In compliance with time reversal acoustic principles this energy is “re-assembled” at the precise location where the original perturbation was originally produced by way of one of the perturbation methods (such as laser impulse, mechanical impact, ellipsoid enhanced acoustic/ultrasonic method etc.). At this point in time the system is said to be pre-trained by way of the time reversal acoustic method. This first cycle of iteration is said to represent a profile in memory (the time reversed pattern stored in memory). This first training cycle represents a single point in two or three-dimensional space.

In order to achieve the equivalent wave directionality control of a multi-transducer physical phased (or complex virtual phased array—CVPA) many positions of impact energy generation must be systematically produced ‘point by point’ with associated time reversal processing such that a multitude of point profiles become stored in memory, which is dependent on the requirements of a given application (the process specifics are dictated by the required/desired resolution of the acquired steps in two or three dimensional space and the allotted time for the scanning at run time—in particular when a transducer or material are moving at high velocities relative to one another, as opposed to being stationary etc.).

Once the desired group of spatial ‘point’ profiles are pre-trained and stored in memory the pre-training process is said to be completed. This pre-training process can be time consuming and is therefore not meant to be part of the process once a MMECCT device is put into use for its ultimate real-time application at so called launch or run-time.

The only aspect of this process that is utilized at run time and in real-time is the stored time reversed profiles in memory. These profiles are used to provide time series patterns employed to produce the concentrated energy which excite a given material under test with a concentrated fine focal spot of concentrated energy which originally was produced by the specific chosen energy source (laser etc. in the initiation process at pre-training/offline time).

### Emission/Excitation/Perturbation Sources

It is noted that perturbation sources can be designed to be broadly different in the intensity and frequency spectrum of energy produced and are to be selected for this time reversal pre-training process to yield the best results for a given application. Note, defect free material is used in this process as opposed to material with defects so as to provide patterns of normal material response exemplars. In reality such normal material profiles may be composites of averaged captures of data collected for a single impact point through many iterations so as to provide a more general composite of many blended responses (all to construct an optimized energy stored profile for any single point).

As noted above, this pre-training time reversal process can be applied for low frequency pump emission purposes, high frequency probe emission purposes, or any combination of frequency band and emission intensities. Additionally, because of the effectiveness of the integrated metamaterial filters the entire process can be further optimized by way of special tailoring of the frequency and time domain characteristics of the excitation/emission/perturbation that is initiating the time reversal pre-training process.

For example, a special exactly solvable chaos (ESC) source could initiate the time reversal pre-training process. Exactly solvable chaotic time series sources have the characteristics of chaos (broadband emission spectrum) but with a provable (known) time series progression. Initiating the time reversal pre-training with an ESC source has several distinct advantages.

For example, the ESC time series in uniquely primed/seeded with a well-defined initial condition a priori for any given source emitter. As a consequence, the specific time series progression is ‘exactly’ known (therefore the term: “exactly solvable chaos”), since it is “exactly solvable” based on the specific value that was defined for the ESC time series (chaotic patterns being a function of initial conditions causing large deviations in ultimate outcomes). This makes it possible to detect the ESC signal when the signal to noise ratio is very poor (perhaps a signal to noise ratio well below 0 dB in well-established cases).

Having this ESC capability in a multiple source emitter configuration (where dozen or even hundreds of MMECCT sources are emitting simultaneously, or emitting in overlapping manners, producing very complex noise/clutter pathologies) provides an opportunity to simplify, what would normally be a much more complicated processing challenge. In such a “multi-source” implementation the challenge for any given source/emitter and associated local response detector/sensor cluster is to ‘sort out’ the signals that are associated with one another (and reject signals relating to entirely different source emission) is normally extremely challenging.

Utilizing ESC greatly reduces the signal processing complexity in these highly complex cluttered scenarios. Due to the fact that each ESC source can prime/seed/initiate its own chaotic pattern uniquely—each source/emitter's emission is uniquely coded and can therefore be more easily decoded by the detector/sensors receiving the response from an anomalous (defected) material under test.

Another important aspect of ESC (and applicable to other advanced modulation methods such pulse compression etc.) is related to the simplicity that an associated perfectly match filter can be construct for optimal detection of a given ESC time series. Matched filters are known to have characteristics that are optimally tailored and matched to a given source/emitter specific time and frequency domain characteristics, such that a response signal (working in concert with detector/sensors) can be optimally detected. Often such filters can be very complex and difficult to implement in either digital or analog form. In the case of ESC time series emissions, a perfectly matched filter takes the form of a simple stable linear infinite impulse response (IIR) or simple finite impulse response (FIR) filter form. This simple optimal filter form for the implementation of a perfectly matched filter for detecting ESC generated source/emitter patterns allows for these very simple filters to be more readily implemented as metamaterial filters in the implementation of the Metamaterial Enhanced Chaotic Cavity Transducer (MMECCT).

ESC source/emitter initiations of the time reversal process are only one of several source/emitter perturbation methods that would be applicable to high performance emission and associated detection schemes. For example, time reversal pre-training source/emitters may generate emissions in the form of frequency/amplitude sweep, step functions, Gaussian pulse, digital, ternary, quad, level pulse compression patterns and so forth. These are just a few limited cases, but all cases benefit from the time reversal pre-training scheme by ultimately producing high density, small focal spot concentrated energy emissions when the corresponding stored profiles are utilized emitted at run-time. Ultimately, this pre-training time reversal scheme with metamaterial filters and impedance matching capability allow for the benefits of the time reversal process when only very short time windows are available for source/emission and return response detector/sensor scheme are a severe limiting factor. The complete time reversal process being two or more complete emission—response cycles is very time consuming and difficult if not impossible to do in time frames under 1000 usec or thereabouts.

According to the present invention, the MMECCT map be deployed in a multitude of applications and anomaly/defect related material integrity applications sectors which include (but not limited to): single integrated pitch/catch MMECCT where emission and return response signal is being processed within the same device as in a pulsed echo mode etc. and separate MMECCTs acting as source/emitters and detector/sensor as separate entities but typically working in conjunction with one another, as in the case of a pitch/catch arrangement, as one example.

According to the present invention, the MMECCT may be deployed in a multitude of applications and anomaly/defect related material integrity applications sectors which include (but not limited to): inline inspection of tubulars, downhole material evaluation, and structural health monitoring components, etc.

MMECCT devices are key components of larger assemblies and systems in these and other categories of material quality inspection (such as shown in FIGS. 1-3, as a limited number of examples).

The present invention provides an MMECCT that enhances capability to scan and focus emitted ultrasonic/sonic signals in real time to optimize signal to noise ratio of nonlinear frequency anomaly (defect) material response related frequency spectra. This is accomplished by integrating metamaterial filters within or attached to a chaotic cavity structure, integrating metamaterial impedance matching layers within or attached to a chaotic cavity structure, pre-training via time reversal processes used in conjunction with a transducer attached to a chaotic cavity with associated integrated filter and impedance matching MM to implement profiles to implement the simplified pre-trained virtual phased array concept, and providing the capability to perform optimized energy emissions in real-time at run-time with less computational overhead, complexity, size, cost, etc. than methods previously used for implementing virtual phased arrays (known as a complex virtual phased arrays—CVPA) or physical multi-transducer/sensor phased arrays.

Additionally, predetermined time reversed optimized “scanning point profiles” (stored in memory for later use at run-time/launch) greatly accelerate and simplify the process of ‘real-time scanning’ in the implementation of a simplified pre-trained virtual phased array as required in very short emission response time frames.

The present invention also provides time reversal pre-training techniques utilized in conjunction with a source/emitter and/or detector/sensor in conjunction with a chaotic cavity to create virtual emission and detection points by enhancing the focal spot size and energy concentration of the emitted signal thereby improving the signal to noise ratio and defect related frequency spectra response.

The integrated metamaterial filter concept provides, as an example, a highly optimized means to tailor filter characteristics to the system requirements as in the case of using exactly solvable chaos as a perturbation source.

The optimal integrated metamaterial matched filter associated with an exactly solvable chaotic excitation source (as well as other advanced excitation methods such as pulse compression techniques deployed with associated matched filters etc.) does not have the deficiencies of a digital or analog electronic filter implementation.

Such deficiencies of implementation methods other than integrated metamaterials (such as those based on electronic digital or analog systems) would include larger size, slower speed of processing, higher power requirements, greater heat dissipation, greater failure susceptibility, more difficult systems integration, and higher cost etc.

Further, the present invention provides integrated metamaterial filters and metamaterial impedance matching layers to greatly improve signal to noise ratio and resultant frequency spectra response of defect related signals both when time reversal pre-training is conducted and at ‘run time’ with less complexity, size, cost, reliability, and greater performance as compared to alternate techniques such as digital filtering and/or hardware analog filters.

Solid state nature of metamaterial filters and metamaterial matching layers allow for sections of the composite sensor to be readily upgraded due to the fact that electrical connections are not required for these implementations as in the case of digital or analog filter implementations. Upgrades would also apply to customization of tools for different purposes (such as change in material under test thickness, type of defect to be detected etc.).

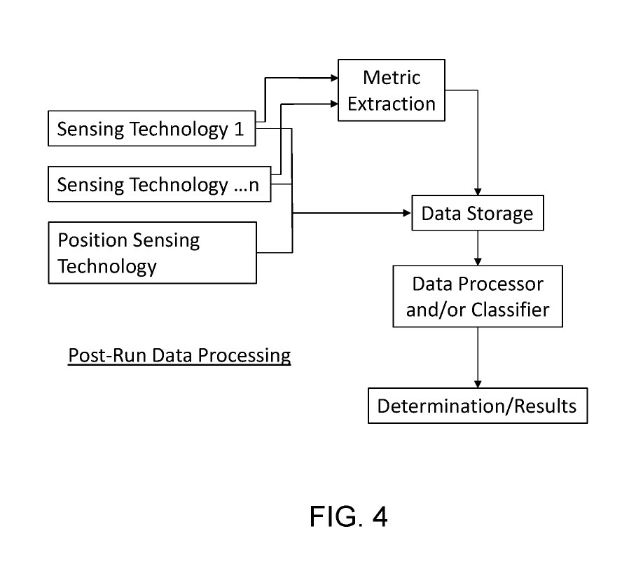

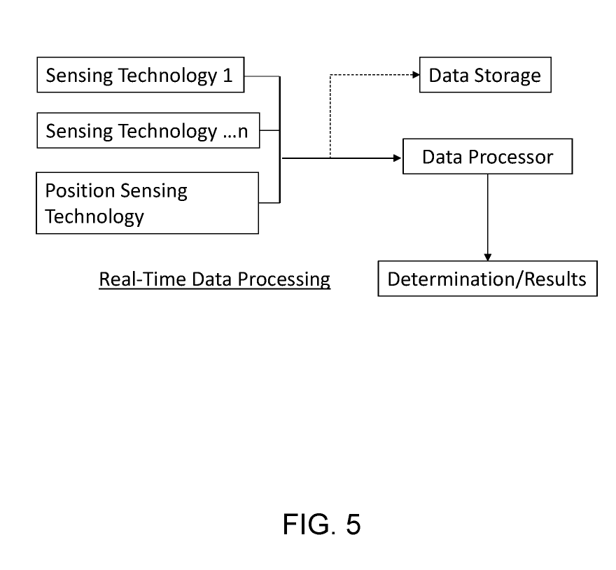

The present invention may collect and process data via a data processor, which may be part of the tool or may be remote from the tool (and may process data transmitted from the tool or collected by the tool and processed after the tool has completed its data collection). The processing steps are shown, for example, in FIGS. 4 and 5.

Therefore, the present invention provides a tool that can be operated in pipelines (e.g., inline inspection), downhole applications, other tubulars and structures of various geometry, for the purpose of crack detection as an example. The tool utilizes means for positional and/or spatial relationship via items such as a caliper, encoder, gyroscopic devices, inertial measurement unit (IMU), and/or the like. The tool may also utilize a caliper module for determination of geometry flaws, dents, etc. The tool utilizes metamaterials on at least one module.

Optionally, the tool of the present invention may utilize individual sensor(s) or array(s) (with or without metamaterials) unlimitedly disposed in uniform or non-uniform arrangements/patterns for the sensing technologies and/or methods. The tool may utilize an electro-magnetic acoustic transducer to impart acoustic energy into the material under test in conjunction with metamaterials.

The tool may store data on-board, or may transmit it to a remote location for storage (and/or processing), or a combination of both. The tool may employ advanced data processing techniques to isolate and extract useful data as required. The tool may employ advanced data processing techniques that use a single sensing technology and/or method, or any combination of sensing technologies (together or individually) and/or methods. Data processing may be conducted in real-time during tool operation, off-loaded externally to be conducted after completion of a tool operation, or a combination of both.

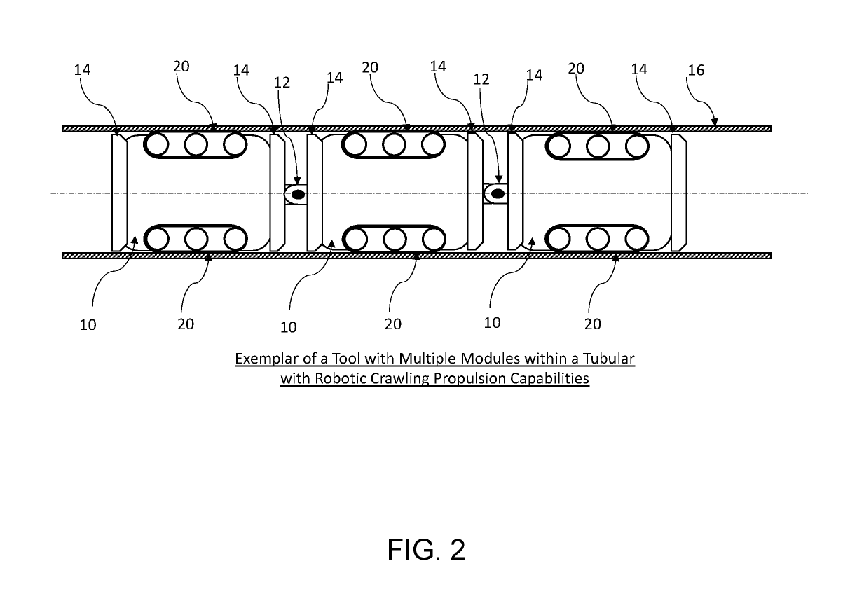

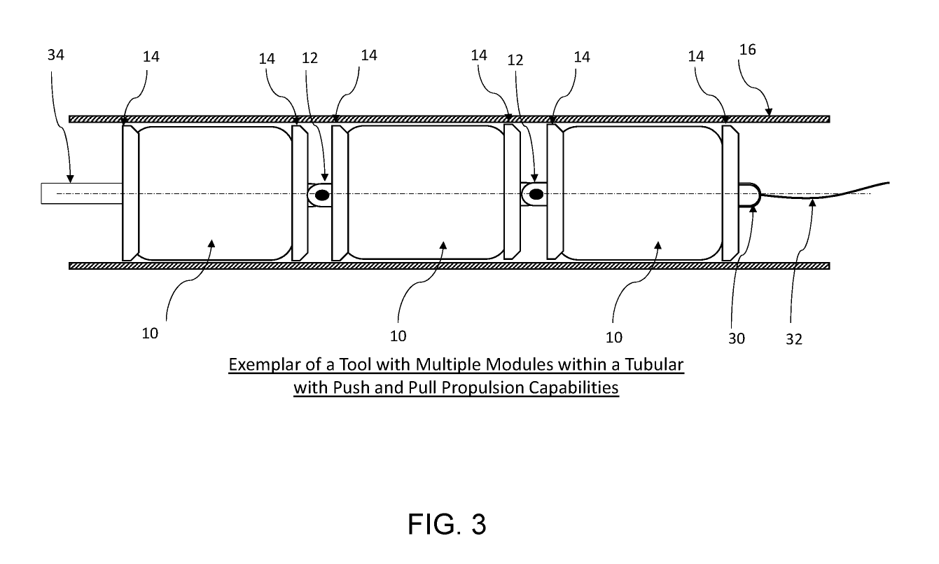

An example of a tool suitable for such crack detection is shown in FIG. 1. The tool comprises a plurality of modules 10 coupled together by respective universal joints 12, with each module 10 having a drive cup and/or cleaning ring 14. The tool is moved along the tubular 16, whereby sensing devices of the modules operate to sense the presence of cracks at the tubular, as discussed below. Optionally, and such as shown in FIG. 2, the tool may be self-propelled. The modules 10 of a tool may have a tracked drive 20 that operates to move the tool and modules along the tubular 16. Optionally, and such as shown in FIG. 3, the forwardmost module 10 of the tool may include a pull loop 30 that attaches to a pull cable 32, and/or the rearwardmost module 10 of the tool may have a coiled tube or pushing device 34, that function to move the tool and modules along the tubular 16. The tool may also be propelled by a gaseous or liquid medium pressure differential (such as shown in FIG. 1) or a combination of any such propulsion means.

Optionally, the tool may be powered on-board, remotely, or a combination of both. The tool may have a system and method to clean surfaces for better sensing abilities, and that system may be incorporated with at least one module if utilized in the tool.

The tool may be operated in tubulars with a wide variety of diameters or cross-sectional areas. Optionally, the tool may be attached to other tools (such as, for example, material identification, magnetic flux leakage, calipers, etc.). The tool may simultaneously use the aforementioned sensing technologies and/or enhancements with existing tools' sensing capabilities and/or system(s)—(such as, for example, crack detection system(s) utilize other tool capabilities simultaneously through shared componentry, magnetic fields, perturbation energy, waves, etc.).

The tool may include the means to determine position/location/distance such as, but not limited to, global positioning system(s), gyroscopic systems, encoders or odometers, etc. The tool may include the means to determine position, location or distance that stores this data on-board or transmits it to a remote location, or a combination of both. The tool may combine the position, location or distance data simultaneously with sensing data collection at any discrete location within the tubular, or on a structure's surface.

An additional version of a tool may be configured to be mounted externally to a tubular via fixture, frame, cabling, etc. to detect cracks on the exterior surface(s). This version of the tool may have a sensing “suite” that is moved manually, is powered, or is pre-programmed to operate in a pattern.

The tool may utilize a transduction method such as time reversal techniques (via processing code) applied to one or more impedance methods included herein as an enhancement. The tool may utilize virtual phased arrays in the form of one or more virtual emitters and one or more virtual receivers.

The tool may be configured to be conveyed within a borehole to evaluate a tubular within the borehole. The tool may further include a conveyance device configured to convey the tool into the borehole. The tool may be configured to be conveyed into and within the borehole via wireline, tubing (tubing conveyed), crawlers, robotic apparatuses, and/or other means.

Therefore, the present invention provides a tool or device that utilizes a sensing system or device or means to sense and collect data pertaining to cracks in the pipe or conduit or other structures in or on which the tool is disposed. The tool utilizes a metamaterial to enhance sensing and/or performance of the tool. The collected data is processed and analyzed to determine the cracks in the pipe or structure at various locations along the conduit or pipeline or structure.

Optionally, aspects of the tool and system of the present invention may be utilized for freepoint sensing purposes, positive material identification (PMI) sensing purposes and stress mapping purposes, while remaining within the spirit and scope of the present invention.

Changes and modifications to the specifically described embodiments may be carried out without departing from the principles of the present invention, which is intended to be limited only by the scope of the appended claims as interpreted according to the principles of patent law including the doctrine of equivalents.

1. A crack detecting system operable to detect cracks along a conduit or structure, said crack detecting system comprising:
a tool movable along a conduit or structure and having at least one sensing device for sensing cracks in a wall of the conduit or structure;
wherein said tool includes at least one component that comprises a metamaterial;
a processor operable to process an output of said at least one sensing device; and
wherein, responsive to processing of the output by said processor, said processor determines cracks present at the wall of the conduit or structure.

2. The crack detecting system of claim 1, wherein said tool comprises at least one module with each module having at least one sensing device.

3. The crack detecting system of claim 1, wherein said tool comprises at least two modules with each module having a respective sensing device.

4. The crack detecting system of claim 1, wherein said processor determines cracks at an interior surface of the conduit or structure.

5. The crack detecting system of claim 1, wherein said processor determines the cracks at an exterior surface of the conduit or structure.

6. A crack detecting system operable to detect cracks along a conduit or structure, the crack detecting system comprising:
a tool movable along a conduit or structure and having at least one sensing device for sensing cracks in a wall of the conduit or structure;
wherein the sensing device comprises a metamaterial enhanced chaotic cavity transducer;
a processor operable to process an output of the at least one sensing device;
wherein, responsive to processing of the output by the processor, the processor determines cracks present at the wall of the conduit or structure.

7. The crack detecting system of claim 6, wherein the metamaterial enhanced chaotic cavity transducer comprises a metamaterial filter.

8. The crack detecting system of claim 7, wherein the metamaterial enhanced chaotic cavity transducer comprises impedance matching layers disposed within or on a chaotic cavity structure.

9. The crack detecting system of claim 8, wherein the sensing device comprises a time reversal technique.

10. The crack detecting system of claim 9, wherein the time reversal technique comprises pre-trained time reversal emission profiles.

11. The crack detecting system of claim 7, wherein the metamaterial enhanced chaotic cavity transducer comprises an exactly solvable chaos source.

12. The crack detecting system of claim 7, wherein the metamaterial enhanced chaotic cavity transducer comprises a pulse compression source.

13. A method for detecting cracks along a conduit or structure, the method comprising:
providing a tool comprising at least one sensing device for sensing cracks in a wall of the conduit or structure, wherein the at least one sensing device comprises a metamaterial enhanced chaotic cavity transducer;
moving the tool along the conduit or structure and collecting data output from the at least one sensor;
processing the data output of the at least one sensing device; and
determining, based at least in part on the processing of the output, cracks at the wall of the conduit or structure.

14. The method of claim 13, wherein the metamaterial enhanced chaotic cavity transducer comprises a metamaterial filter.

15. The method of claim 13, wherein the metamaterial enhanced chaotic cavity transducer comprises impedance matching metamaterial layers disposed within or on a chaotic cavity structure.

16. The method of claim 15, wherein the sensing device comprises a time reversal technique.

17. The method of claim 16, wherein the time reversal technique comprises pre-trained time reversal emission profiles.

18. The method of claim 17, comprising pre-training the sensing device via sensing a test conduit or structure while impacting the test conduit or structure in a predetermined pattern.

19. The method of claim 13, wherein the metamaterial enhanced chaotic cavity transducer comprises an exactly solvable chaos source.

20. The method of claim 13, wherein the metamaterial enhanced chaotic cavity transducer comprises a pulse compression source.
